(19) United States
(12) Patent Application Publication
(10) Pub. No.: US 2026/0209559 A1
(43) Pub. Date: Jul. 23, 2026

(54) WEATHER SEALING

(71) Applicants: DOW SILICONES CORPORATION, Midland, MI (US); DOW CHEMICAL THAILAND LIMITED, Bangkok (TH)

(72) Inventors: Valérie HAYEZ, Seneffe (BE); Peeraphol CHIRAYUCHAROENSAK, Bangkok (TH)

(21) Appl. No.: 19/142,013

(22) PCT Filed: Dec. 12, 2023
(86) PCT No.: PCT/US2023/083498

§ 371 Date: Jun. 20, 2025

Related U.S. Application Data
(60) Provisional application No. 63/434,510, filed on Dec. 22, 2022.

(51) Int. Cl. C09J 5/10; C08J 5/12; C09J 5/02; C09J 183/04; C09K 3/10

(52) U.S. Cl. CPC C09J 5/10; C08J 5/124; C09J 5/02; C09J 183/04; C09K 3/1018; C09K 3/1025; C08J 2383/04; C08J 2483/04; C09J 2483/008; C09K 2003/1081; C09K 2200/0685

(57) ABSTRACT

This disclosure is concerned with improvements in, or to methods for, weather sealing between adjacent building elements used in building construction. The building elements may include but are not restricted to silicone structural glazing units (SSGs), insulating glazing units (IGUs), monolithic transparent panels, and laminated transparent units. The building elements may be utilised in either exterior and/or interior building applications such as, for the sake of example, curtain wall facades, glass surfaces, cable net façades, shop fronts, skylights, conservatories and the like.

This disclosure is concerned with improvements in or to methods for weather sealing between adjacent building elements used in building construction. The building elements may include, but are not restricted to, silicone structural glazing units (SSG), insulating glazing units (IGUs), monolithic transparent panels and laminated transparent units and they may be utilised in either exterior and interior building applications such as, for the sake of example, curtain wall facades, glass surfaces, cable net façades, shop fronts, skylights, conservatories and the like.

In recent years architects have sought to maximize the ingress of light, especially natural light in new buildings and structures e.g., high rise structure utilising SSG curtain surface façades and shop fronts etc. which have assorted other benefits such as, in the case of shop fronts, improving the view of content therein. This has been achieved by increasing the number of transparent elements/components therein. For example, efforts have been made to introduce transparent spacer systems as a means of spacing apart adjacent panels (e.g., of glass) for double glazed and triple glazed panels in insulated glass units (IGUs).

Given the introduction of clear spacers between e.g., adjacent glass panels in IGUs there is now an industry need to maximize the ingress of light, especially natural light through weather seals used to fill cavities/gaps between adjacent construction elements/modules in a building or façade. The elements/modules might include, for example, silicone structural glazing units (SSG), insulating glazing units (IGUs), monolithic glass panels (i.e., tempered and non-tempered flat glass panels) and laminated building elements. However, until recently, weather scaling scalants used to fill and/or form joints in said cavities/gaps between adjacent construction elements/modules have tended to be white or black opaque and in the case of many so-called “clear” sealants a milky white, at best translucent appearance and are not fully transparent. As such light was partially or substantially blocked from entering the building through such weather sealing sections.

Weather seals in a building/construction need to be able have sufficient movement capacity to maintain the seal and/or joint between adjacent building elements, whilst withstanding e.g.,
(i) expansion and shrinkage due to temperature changes,
(ii) expansion and/or shrinkage of the building elements and or materials therein,
(iii) air and water infiltration; as well as
(iv) the effect of wind and vibrations.

Typically, weather seals are prepared using a suitable room temperature curable sealant such as a modified silane polyether sealant (often referred to as an MS sealant), polyurethane sealants and/or silicone sealants. They are typically applied in a flowable state e.g., using a sealant gun and subsequently cure to a solid state to seal the gaps and/or form a joint between adjacent building elements. As an alternative, gaskets may be installed between adjacent glass panels. These may be made from, for example, ethylene propylene diene monomer rubber (EPDM) and may be clipped in place and maintained mechanically within grooves.

In many instances, cured in place silicone sealants made from suitable room temperature curable silicone weather sealant compositions are preferred as weather seals because of their chemical properties. They have excellent resistance to ultraviolet rays and atmospheric aging. They can maintain many years (at least 10 years) of excellent durability without cracking, brittleness and deterioration in harsh environments such as sunlight, rain, snow. They are not significantly affected by seasonal climate changes, as they can maintain stable properties over a wide temperature range. Therefore, such silicone sealants are good weather seals as they efficiently and durably seal the building envelope against wind and water infiltration, which has a huge impact on the energy efficiency of the building and consequently, the comfort of the inhabitants.

Generally, most room temperature curable silicone sealants comprise
(i) an —OH end-blocked diorganopolysiloxane polymer or an alkoxy end-blocked polydiorganosiloxane which may have an alkylene link between the terminal and penultimate silicon atoms as well as
(ii) one or more suitable cross-linking agents designed to react with the —OH and/or alkoxy groups and thereby cross-link the composition to form an e.g., elastomeric sealant product; and
(iii) one or more condensation cure catalysts.

Additional ingredients such as reinforcing fillers, non-reinforcing fillers, adhesion promotors, diluents (e.g., plasticisers and/or extenders), chain extenders, flame retardants, solvent resistant additives, biocides and the like are often also incorporated into these compositions as and when required. Such silicone sealant compositions may be one-part compositions or multiple-part, e.g., two-part compositions.

One-part condensation curing (RTV) silicone compositions are generally utilised to generate skin or diffusion cured silicone elastomers. It is well known to people skilled in the art that alkoxy titanium compounds and/or alkoxy zirconium compounds i.e., alkyl titanates and/or alkyl zirconates are suitable catalysts for curing such one component moisture curable silicones. One-part condensation curing silicone compositions are generally designed not to contain any water/moisture in the composition so far as possible, i.e., they are generally stored in a substantially anhydrous form to prevent premature cure during storage before use. Skin or diffusion cure (e.g., by moisture/condensation) takes place by the formation of a cured skin at the composition/air interface subsequent to the sealant/encapsulant being applied on to a substrate surface. Subsequent to the generation of the surface skin the cure speed is dependent on the speed of diffusion of moisture from the sealant/encapsulant interface with air to the inside (or core) of the layer of silicone composition applied, and the diffusion of condensation reaction by-product/effluent from the inside (or core) to the outside (or surface) of the material and the gradual thickening of the cured skin over time from the outside/surface to the inside/core. Such one-part condensation curing silicone compositions are applied in a layer that is thinner than typically 15 mm. Such compositions, if applied in layers thicker than 15 mm, are known to lead to uncured material in the depth of the material, because moisture is very slow to diffuse into very deep sections. Often to avoid the need to cure such deep sections or to support the resulting cured silicone material joint backer rods may be used. These are, for example, non-absorbent compressible, closed-cell polyethene foams which, when used, are inserted into a joint to control sealant depth and create a backstop to allow proper sealant tooling. Such backer rods are not transparent. So, whilst the cured sealant may be translucent (at best) the reliance on such backer rods will ruin the appearance of the weather seal.

The main, if not sole source, of moisture in these one-part condensation curing (RTV) silicone compositions are inorganic fillers, e.g., silica or calcium carbonate when present. Said fillers may be rendered anhydrous before inter-mixing with other ingredients or water/moisture may be extracted from the mixture during the mixing method to ensure that the resulting sealant composition is substantially anhydrous.

The aforementioned transparent spacers for IGUs are in the main unsuitable for use in or for weather seals because they are unable to provide the necessary movement capacity, the latter being impossible with rigid poly(methyl methacrylate) (PMMA) or glass which are bonded with transparent tape without movement capacity. However, one such transparent spacer which was considered a possible option has been developed by Dow Silicones Corporation (formerly Dow Corning Corporation). This is a transparent/clear spacer prepared from a two-part sealant composition, which cures in the bulk of the sealant rather than solely via skin or diffusion. It was surprisingly found that such a spacer can be pre-cured, i.e., it does not need to be cured in place and provides a level of adhesion to glass after it has been cured. Furthermore, contrary to standard teaching, it utilises a titanate and/or zirconate cure catalyst normally reserved for one-part compositions. It was found that providing ingredients in certain ratios enabled bulk cure. It was also identified such a preformed spacer can be securely adhered to substrates which have been previously treated using a so called “intermediate layer” or “reactive interlayer” such as a commercially available primer between the elastomer and the substrate surface as described in WO2017191322A1. The “intermediate layer” or “reactive interlayer” is not being used as a primer in accordance with the normal meaning of the term because the weather seal is pre-cured. Primers are not used to adhere pre-cured elastomers to substrates. Primer materials enhance the adhesion of condensation curable silicone-based compositions to substrate surfaces e.g., metal surfaces. Primers are relatively thin coatings designed to adhere to the surface of a substrate to form a binding layer that is better prepared to receive e.g., silicone sealant or a layer of paint or the like. Typically, the primer will be thinly applied and will dry/cure in a few seconds or minutes. If the user wishes to adhere a sealant material to the substrate surface via the use of the primer subsequent to drying the primer, a layer of uncured sealant is applied to the primed substrate surface and after working or smoothing the applied sealant composition into the desired shape/thickness etc. (if necessary) the sealant is allowed to cure. The fact that the sealant is applied uncured has, historically, been critical in order to generate a chemical interaction between the curing sealant composition at its interface with the primer on the substrate surface. If the sealant is applied onto the primed surface post-cure little or no chemical interaction will take place at the interface because the layer of sealant has pre-cured and therefore has little or no chemically active groups available for chemically binding with active groups at the surface of the binder. In the present invention the term interlayer is used to define suitable liquid coating compositions, not only primers, which may be applied to a surface of a substrate and then dried/cured to provide a surface coating of a submicronic thickness, but also liquid compositions, which cure to provide thicker coatings on the surface of a substrate, which may be millimetric.

Given the pre-cured spacer material described above provides both material clarity and movement capacity it was considered to be a possible option but it was found that the method used for adhering the spacers to glass could not be used as the means for inserting the preformed silicone sealant material into the gaps between adjacent units in order to provide a weather seal.

There is provided herein a method of weather-sealing a cavity having a pre-defined nominal joint size, formed between a planar surface of a first building element which is transparent and a planar surface of an adjacent second building element which is facing said planar surface of the first building element and which is optionally at least partially transparent, which method comprises the steps of:
(i) applying a coating of a one component, translucent silicone sealant composition on the planar surface of either the first or second building elements;
(ii) applying a coating of a one component, translucent silicone sealant composition on the planar surface of the other of the first or second building elements;
   (iii) inserting a pre-cured strip of a transparent silicone weather seal material having a circular or oval cross-section with a diameter of from 110% to 150% of the pre-defined nominal joint size between the planar surface of said first building element which is transparent and the planar surface of the adjacent second building element which is optionally at least partially transparent facing each other;
   (iv) removing any excess one component, translucent silicone sealant composition applied in step (i) or step (ii) subsequent to step (iii); and
   (v) allowing or enabling the remaining one component, translucent silicone sealant composition to cure and form a weather seal by adhering the pre-cured strip of a transparent silicone weather seal material inserted in step (iii) to both the first and second building elements.

The pre-cured strip of a transparent silicone weather seal material having a circular or oval cross-section with a diameter of from 110% to 150% of the pre-defined nominal joint size has a continuous/solid cross-section which is not hollow. In one embodiment, if desired, a coating of a one component, translucent silicone sealant composition may be applied onto said pre-cured strip of a transparent silicone weather seal material subsequent to insertion into the cavity to enhance the clarity/transparency of said strip of a transparent silicone weather seal material.

The “nominal joint size” is the designed width of the cavity between the adjacent first and second building elements.

Using a pre-cured strip of a transparent silicone weather seal material as a significant part of a weather seal between adjacent building units prepared in accordance with the above method necessitates that the pre-cured strip of a transparent silicone weather seal material inserted during step (iii) must be designed to be sufficiently compressible to be able to be inserted into the cavity and subsequently to engage/adhere to the one component, translucent silicone sealant composition applied in steps (i) and (ii). However, it can't be a rigid strip of material as the weather seal and therefore the pre-cured strip of a transparent silicone weather seal material must accommodate any predefined construction tolerances designed to accommodate imperfections during construction from said nominal joint size along the whole length of the cavity which can lead to the cavity between the building elements not having constant/homogeneous dimensions in order to achieve an impervious weather seal. Furthermore, such a weather seal and as such the pre-cured strip of a transparent silicone weather seal material must also be able to accommodate any thermal movement capability of the building elements resulting in expansion and contraction during construction.

Hence the resulting weather seal between adjacent building elements and consequently the pre-cured strip of a transparent silicone weather seal material must also be able to expand and contract to follow the movement of the building elements. Hence the nominal joint size is a guide as to the standard cavity width but the weather seal generated as a result of the method described herein must have the capability to accommodate such variations during the life of building in order for the weather seal to remain impervious to the weather conditions to be encountered. In one embodiment the or a diameter of the pre-cured strip of a transparent silicone weather seal material having a circular or oval cross-section is greater than the nominal joint size+the predetermined maximum construction tolerance.

For the avoidance of doubt the oval cross-section has two diameters, a first diameter that runs through the shortest part of the oval i.e., along the semi-minor axis, and the diameter that runs through the longest part of the oval i.e., along the semi-major axis. The oval may be an ellipse. Typically, at least the diameter along the semi-major axis of the oval is from 110% to 150% of the nominal joint size between the planar surface of said first building element which is transparent and the planar surface of the adjacent second building element which is optionally at least partially transparent, which are facing each other.

In one embodiment the first building element which is transparent and optionally the second building element is/are selected from insulating glazing units (IGUs) including vacuum insulating glazing units, monolithic glass panels (e.g., tempered and non-tempered flat glass panels), laminated building elements (e.g., laminated glass), cast glass (e.g., glass bricks and other cast glass building components), polymethylmethacrylate unit (alternatively referred to as (meth)acrylic glass) (e.g., used for achieving curved elements) and transparent building elements (e.g., used for conservatories or skylights/roof lights) including the use of IGUs and/or glass for skylights, as well as polycarbonate (PC) transparent building elements (e.g., used for conservatories or skylights/roof lights). In one embodiment the adjacent second building element is at least partially transparent. The partially transparent section may be selected from insulating glazing units (IGUs), monolithic glass panels (e.g., tempered and non-tempered flat glass panels), laminated building elements (e.g., laminated glass), cast glass (e.g., glass bricks and other cast glass building components), polymethylmethacrylate unit (alternatively referred to as (meth)acrylic glass) (e.g., used for achieving curved elements) and transparent building elements (e.g., used for conservatories or skylights/roof lights which may be constructed from polycarbonate (PC) or alternatives. In another embodiment the adjacent second building element is completely transparent.

When the adjacent second building element is not transparent it may comprise for the sake of example metal, e.g., steel or aluminium, wood, concrete bricks or other non-transparent construction materials and the like.

When the adjacent second building element is transparent or at least partially transparent it may comprise insulating glazing units (IGUs), monolithic glass panels (i.e., tempered and non-tempered flat glass panels) and laminated building elements, e.g., laminated glass, glass panels, cast glass which covers e.g., glass bricks and other aesthetic systems and polymethylmethacrylate units used e.g., used for achieving curved elements.

The adjacent planar surfaces of the first and second building elements which are facing each other may or may not be parallel. In one embodiment the adjacent planar surfaces of the first and second building elements which are facing each other are parallel.

The weather seal may be between any suitable facing planar surfaces of the first and second adjacent building elements. For the sake of example, where the first and second building elements are both double glazed insulated glazing unit (IGU), the weather seal may be formed between facing panes of glass of adjacent IGUs which are not situated in the same plane.

In another embodiment the weather seal is formed between facing edges of two adjacent building elements such as IGUs and/or laminated glass units or the like, which are facing each other and which are fixed in position to function in the same plane or substantially the same plane. This will be further explained in the figures below. The width of the cavity formed between the adjacent first and second building elements can be inconsistent over the length of the building elements in accordance with predefined construction tolerances and therefore the resulting combination of cured one component, translucent silicone sealant and the pre-cured strip of a transparent silicone weather seal material having a circular or oval cross-section inserted in step (iii) of the method need to be able to accommodate any such inconsistencies and form a functioning weather seal joint along the whole length of the adjacent planar surfaces of the first and second building elements.

The width of the cavity and the nominal joint size may be in a range of 5 to 50 mm, alternatively from 5 to 45 mm, alternatively from 5 to 30 mm, alternatively from 5 to 30 mm. Typically, when using a one component, translucent silicone sealant the depth of the cavity will be no greater than 15 mm and preferably the width (mm):depth (mm) ratio will be from 3:1 to 1:1. Use of two-component bulk cure sealants allows the depths to be larger. In the present disclosure the pre-cured strip of a transparent silicone weather seal material can be prepared to any suitable specification to replace the sealant in the weather seal. The values given below and in the following examples are nominal joint size values unless otherwise indicated. However the actual width of the cavity may vary for example where the length of the first and second building elements are for the sake of example 6m the width of the cavity might be e.g., 10 mm at one end thereof, allowing for compression in accordance with the construction tolerance for the width of the cavity and 15 to 20 mm at the other end, allowing for expansion in accordance with the construction tolerance for the width of the cavity.

The depth of the cavity is dictated by the thickness of the first and second building elements between which a cavity is formed and can vary from 10 mm to 100 mm in depth dependent on the structure of the building elements. The adjacent planar surfaces of the first and second building elements facing each other are approximately parallel to each other but they may not be as discussed in the Figures. It is to be appreciated that the above dimensions are all approximate and that the present method is designed to accommodate such variations. In the case of in WO2017191322A1 as discussed above an intermediate layer or reactive interlayer was utilised to adhere the spacer to the substrates being spaced apart. For the purposes of this application such an arrangement was tested for use of adhering a pre-cured strip of a transparent silicone weather seal material to the planar surfaces of the adjacent first and second building elements but it was found not to be suitable, as will be discussed further below and after a series of tests it was found that the most suited adherent for the purpose of weather sealing as described herein was the use of a thin layer of a one component, translucent silicone sealant such as a one component, translucent neutral-cure silicone sealant (e.g., having an average thickness of less than 2 mm thick (approximate) when applied and after tooling. The one component, translucent silicone sealant is applied onto both planar surfaces of the first and second building elements forming the cavity in steps (i) and (ii) of the method herein prior to the introduction of the pre-cured strip of a transparent silicone weather seal material, i.e., it was found that surprisingly a very thin coating of a standard one-part translucent silicone sealant such as a one component, translucent neutral-cure silicone sealant did not have a significantly negative affect on the transparency of the assembly when coated on the planar surfaces of the adjacent first and second building elements given the transparent nature of the pre-cured strip of transparent silicone weather seal material.

It was also found that the use of such layers when cured in place between the adjacent planar surfaces and the pre-cured strip of a transparent silicone weather seal material provided the resulting weather seal with an acceptable tensile strength and therefore the ability to accommodate sufficient movement capacity at times e.g., when the first and second building elements expand or contact due to weather variations. ensuring high transparency, especially on the edge and increased the strength of adhesion.

In one embodiment, masking tape can be applied to the edge regions of each face of the first and second building elements not treated in step (i) or step (ii) of the method in order to protect same. Once the masking tape has been applied a thin bead of one component, translucent silicone sealant is applied onto either of the adjacent planar surfaces of the first or second building elements and this bead can be spread using a suitable tool to leave an as even coating as possible of the one component, translucent silicone sealant composition thereon and then the same can be undertaken on the facing planar wall of the adjacent building element. The beads of one component, translucent silicone sealant may be provided using a sealant gun or any other suitable means of application.

It was found that one advantage of weather seals generated by the method herein was that backer rods were not required to control depth of the sealant used. This is particular promising as the backer rods usually used are not transparent and as such the need for same would impair the transparency of the weather seal generated.

Any suitable one component, translucent silicone sealant may be utilised in step (i) and step (ii) of the method. They typically comprise, for the sake of example of an alkoxysilyl or silanol terminated silicone polymers such as polydimethylsiloxane having two or more alkoxy-silyl groups or silanol groups per molecule, one or more reinforcing fillers for example fumed or precipitated silica, a suitable silane cross-linker and a zirconate or titanate catalyst. Such materials may also incorporate one or more of the following additives, plasticizers, rheology modifiers, thickeners, adhesive promoters, catalysts, accelerators, drying agents, odorants, pigments, biocides, stabilizers and surfactants. Examples of commercial translucent weather sealants which may be utilised for the sealant layer in steps (i) and (ii) of the method include neutral weatherproofing sealants such as DOWSIL™ 791T Silicone Weatherproofing Sealant and DOWSIL™ 799T Silicone Weatherproofing Sealant, acetoxy sealants such as DOWSIL™ 781 Acetoxy Sealant, DOWSIL™ 784 Silicone Sealant, DOWSIL™ 785 Sanitary Acetoxy Silicone DOWSIL™ 793T Glazing Sealant Translucent DOWSIL™ 768 Neutral Cure Sealant Clear, With Fungicide all commercially available from Dow Silicones Corporation of Midland, Michigan, USA as well as suitable oxime sealants. In one embodiment, the sealant utilised for step (i) and step (ii) of the method is a neutral sealant.

It was found that after considerable testing, use of a pre-cured strip of a transparent silicone weather seal material having a circular or oval cross-section with diameter of from 110% to 150% of the nominal joint size was the optimum means of ensuring the cavity is suitably sealed with the strip of pre-cured transparent silicone weather seal material compressed in order to be installed into the cavity and then allowed to expand to fill said cavity once introduced therein. The pre-cured strip of a transparent silicone weather seal material is compressible and as such it is also suited to enable movement of the transparent silicone weather seal material between the planar surface of said first building element which is transparent and the planar surface of the adjacent second building element which is optionally at least partially transparent, e.g., due to expansion and/or contraction due to external weather conditions.

For example, the composition utilised in the preparation of the pre-cured strip of a transparent silicone weather seal material may be the same or similar to those used for making spacers in WO/2018/160325 which is incorporated herein by reference. The compositions are two-part room temperature curable silicone compositions which produce suitable elastomeric articles. The bulk cured room temperature condensation curable silicone composition used herein to form elastomeric articles may be any suitable two-part room temperature curable silicone composition which relies on a titanate cure catalyst. Such a composition is preferably designed to, at least substantially, cure in bulk and preferably does not contain any inorganic reinforcing filler. Such a composition, given the lack of filler, may be flowable and self-levelling at the commencement of the cure method.

The bulk cured room temperature condensation curable silicone composition may comprise:
(i) at least one condensation curable silyl terminated polymer having an average of at least 1.5, alternatively an average of at least two hydrolysable and/or hydroxyl functional groups per molecule;
(ii) a cross-linker selected from the group of
   silanes having at least two hydrolysable groups, alternatively at least 3 hydrolysable groups per molecule group; and/or
   silyl functional molecules having at least 2 silyl groups, each silyl group containing at least one hydrolysable group.
(iii) a condensation catalyst selected from the group of titanates and zirconates;
   characterized in that:
      the molar ratio of hydroxyl groups to hydrolysable groups is between 0.1:1 to 4:1;
      and the molar ratio of M-OR functions to the hydroxyl groups is from 0.01:1 and 0.6:1, where M is titanium or zirconium and R is an alkyl group.

The composition is stored in two-parts prior to use to avoid premature curing and then the two-parts are mixed in a predefined ratio (e.g., a weight ratio) immediately prior to use. As previously indicated, immediately after mixing the resulting viscosity of the composition may be sufficiently low for the composition to be flowable. For example, the part A of the composition may be merely a 13,500 mPa·s (at 25° C.) silanol terminated polydimethylsiloxane and part B of the composition or cure package comprised 100 weight parts of a 2,000 mPa·s trimethoxysilyl terminated polydimethylsiloxane (at 25° C.) and 0.3 weight parts of tetra-n-butyl titanate, per 100 weight parts of said trimethoxysilyl terminated polydimethylsiloxane. Viscosity may be measured using a rheometer such as an Anton-Paar MCR-301 rheometer fitted with a 25 mm cone-and-plate fixture and operated at 25° C. or if desired using a Brookfield™ rotational viscometer using Spindle LV-4 for viscosities over 15,000 mPa·s (Spindle LV-4 designed for viscosities in the range between 1,000-2,000,000 mPa·s) and adapting the speed according to the polymer viscosity taken at 25° C. unless otherwise indicated.

Polymer (i) is at least one or more than one moisture/condensation curable silyl terminated polymer. Any suitable moisture/condensation curable silyl terminated polymer may be utilised including polydialkyl siloxanes, alkylphenyl siloxane, or organic based polymers with silyl terminal groups e.g., silyl polyethers, silyl acrylates and silyl terminated polyisobutylenes or copolymers of any of the above. Preferably the polymer is a polysiloxane based polymer containing at least two hydroxyl or hydrolysable groups, most preferably the polymer comprises terminal hydroxyl groups. Examples of suitable hydroxyl or hydrolysable groups include —Si(OH)₃, —(R^{a})Si(OH)₂, —(R^{a})₂Si(OH), —R^{a}Si(OR^{b})₂, —Si(OR^{b})₃, —R^{a}₂SiOR^{b} or —(R^{a})₂ Si—R^{c}— SiR^{d}ₚ(OR^{b})₃₋ₚ where each R^{a} independently represents a monovalent hydrocarbyl group, for example, an alkyl group, in particular having from 1 to 8 carbon atoms, (and is preferably methyl); each R^{a} and R^{d} group is independently an alkyl or alkoxy group in which the alkyl groups suitably have up to 6 carbon atoms; R^{a} is a divalent hydrocarbon group which may be interrupted by one or more siloxane spacers having up to six silicon atoms; and p has the value 0, 1 or 2. Preferably the at least two hydroxyl or hydrolysable groups are all OH groups.

Preferably polymer (i) has the general formula:

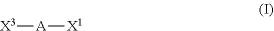

where X³ and X¹ are independently selected from siloxane groups which terminate in hydroxyl or hydrolysable groups, alternatively hydroxyl groups and A is a siloxane containing polymeric chain. Examples of hydroxyl-terminating or hydrolysable groups X³ or X¹ include: —Si(OH)₃, —(R^{a})Si(OH)₂, —(R^{a})₂Si(OH), —(R^{a})Si(OR^{b})₂, —Si(OR^{b})₃, —(R^{a})₂SiOR^{b} or —(R^{a})₂ Si—R^{c}— Si(R^{d})ₚ(OR^{b})₃₋ₚ as defined above with each Rb group, when present, typically being a methyl group. Preferably the X³ and/or X¹ terminal groups are hydroxydialkyl silyl groups, e.g., hydroxydimethyl silyl groups or alkoxydialkyl silyl groups e.g., methoxydimethyl silyl or ethoxydimethyl silyl. Most preferably the at least two hydroxyl or hydrolysable groups are all OH groups.

Examples of suitable siloxane groups in polymeric chain A of formula (1) are those which comprise a polydiorgano-siloxane chain. Thus, polymeric chain A preferably includes siloxane units of formula (2)

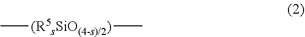

in which each R⁵ is independently an organic group such as a hydrocarbyl group having from 1 to 10 carbon atoms optionally substituted with one or more halogen group such as chlorine or fluorine and s is 0, 1 or 2, typically they are linear chains where s=2. Particular examples of groups RSinclude methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group. Suitably, at least some and preferably substantially all of the groups R⁵ are methyl.

Typically, the polymers of the above type will have a viscosity in the order of 1000 to 300 000 mPa·s, alternatively 1000 to 100 000 mPa·s at 25° C. measured by using an Anton-Paar MCR-301 rheometer fitted with a 25 mm cone-and-plate fixture and operated at 25° C.

Preferred polysiloxanes containing units of formula (2) are thus polydiorganosiloxanes having terminal, silicon-bound hydroxyl groups or terminal, silicon-bound organic radicals which can be hydrolysed using moisture as defined above. The polydiorganosiloxanes may be homopolymers or copolymers. Mixtures of different polydiorganosiloxanes having terminal condensable groups are also suitable.

Polymeric chain A may alternatively be an organic based polymer with silyl terminal groups e.g., silyl polyethers, silyl acrylates and silyl terminated polyisobutylenes. In the case of silyl polyethers the polymer chain is based on polyoxyalkylene based units. Such polyoxyalkylene units preferably comprise a linear predominantly oxyalkylene polymer comprised of recurring oxyalkylene units, (—CₙH₂ₙ—O—) illustrated by the average formula (—CₙH₂ₙ—O—)_{y} wherein n is an integer from 2 to 4 inclusive and y is an integer of at least four. The number average molecular weight of each polyoxyalkylene polymer block may range from about 300 to about 10,000 but can be higher in number average molecular weight. Moreover, the oxyalkylene units are not necessarily identical throughout the polyoxyalkylene monomer but can differ from unit to unit. A polyoxyalkylene block, for example, can be comprised of oxyethylene units, (—C₂H₄—O—); oxypropylene units, (—C₃H₆—O—); or oxybutylene units, (—C₄H₄—O—); or mixtures thereof.

Other polyoxyalkylene units may include for example: units of the structure:

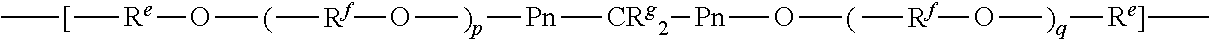

in which Pn is a 1,4-phenylene group, each R^{e} is the same or different and is a divalent hydrocarbon group having 2 to 8 carbon atoms, each R^{f} is the same or different and, is, an ethylene group or propylene group, each R^{g} is the same or different and is, a hydrogen atom or methyl group and each of the subscripts p and q is a positive integer in the range from 3 to 30.

For the purpose of this application “Substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms: oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

The backbone of the organic polymer (A) which may contain organic leaving groups is not particularly limited and may be any of organic polymers having various backbones. The backbone preferably includes at least one selected from a hydrogen atom, a carbon atom, a nitrogen atom, an oxygen atom, and a sulphur atom because the resulting composition has excellent curability and adhesion.

Crosslinkers (ii) that can be used are generally moisture curing silanes having at least two hydrolysable groups, alternatively at least 3 hydrolysable groups per molecule group; and/or silyl functional molecules having at least 2 silyl groups, each silyl group containing at least one hydrolysable group.

Typically, a cross-linker requires a minimum of two hydrolysable groups per molecule and preferably 3 or more. In some instances, the crosslinker (ii) having two hydrolysable groups may be considered a chain extender. The crosslinker (ii) may thus have two but alternatively has three or four silicon-bonded condensable (preferably hydroxyl and/or hydrolysable) groups per molecule which are reactive with the condensable groups in organopolysiloxane polymer (i). Typically, the cross-linker (ii) will only have two hydrolysable groups when polymer (i) has at least 3 hydroxyl-terminating or hydrolysable groups to ensure cross-linking rather than chain extension. For the sake of the disclosure herein silyl functional molecule is a silyl functional molecule containing two or more silyl groups, each silyl group containing at least one hydrolysable group. Hence, a disilyl functional molecule comprises two silicon atoms each having at least one hydrolysable group, where the silicon atoms are separated by an organic or siloxane spacer. Typically, the silyl groups on the disilyl functional molecule may be terminal groups. The spacer may be an organic or siloxane based polymeric chain.

Any suitable cross-linker (ii) may be used for example alkoxy functional silanes, oximosilanes, acetoxy silanes, acetonoxime silanes, enoxy silanes. For softer materials more than one silyl group per molecule is preferable. The crosslinker (ii) used in the moisture curable composition as hereinbefore described is preferably a silane compound containing hydrolysable groups. These include one or more silanes or siloxanes which contain silicon bonded hydrolysable groups such as acyloxy groups (for example, acetoxy, octanoyloxy, and benzoyloxy groups); ketoximino groups (for example dimethyl ketoximo, and isobutylketoximino); alkoxy groups (for example methoxy, ethoxy, and propoxy) and alkenyloxy groups (for example isopropenyloxy and 1-ethyl-2-methylvinyloxy).

Alternatively, the crosslinker (ii) may have a siloxane or organic polymeric backbone. In the case of such siloxane or organic based cross-linkers the molecular structure can be straight chained, branched, cyclic or macromolecular. Suitable polymeric crosslinkers (ii) may have a similar polymeric backbone chemical structure to polymeric chain A as depicted in formula 1 above here above but typically any such crosslinkers ii utilised will be of significantly shorter chain length than polymer i.

The crosslinker (ii) may have two but preferably has at least three or four silicon-bonded condensable (preferably hydroxyl and/or hydrolysable) groups per molecule which are reactive with the condensable groups in organopolysiloxane polymer (a). In one embodiment the cross-linker (ii) used is a disilane having up to 6 hydroxyl and/or hydrolysable groups per molecule. When the crosslinker is a silane and when the silane has three silicon-bonded hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. Preferably however, the fourth silicon-bonded organic group is methyl.

Silanes and siloxanes which can be used as crosslinkers (ii) include alkyltrialkoxysilanes such as methyltrimethoxysilane (MTM) and methyltriethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-methylethylketoximo)silane, methyltris(methylethylketoximino)silane, methyltris(isopropenoxy)silane, vinyltris(isopropenoxy)silane, ethylpolysilicate, n-propylorthosilicate, ethylorthosilicate, dimethyltetraacetoxydisiloxane. The cross-linker used may also comprise any combination of two or more of the above. The cross-linker may be polymeric, with a silicone or organic polymer chain bearing alkoxy functional end groups such as 1,6-bis(trimethoxysilyl)hexane (alternatively known as hexamethoxydisilylhexane).

The composition further comprises a condensation catalyst (iii). This increases the speed at which the composition cures. The catalyst (iii) chosen for inclusion in a particular silicone sealant composition depends upon the speed of cure required. Titanate and/or zirconate-based catalysts (iii) may comprise a compound according to the general formula Ti[OR²²]₄ or Zr[OR²²]₄ where each R²² may be the same or different and represents a monovalent, primary, secondary or tertiary aliphatic hydrocarbon group which may be linear or branched containing from 1 to 10 carbon atoms. Optionally the titanate or zirconate, alternatively titanate may contain partially unsaturated groups. However, preferred examples of R²² include but are not restricted to methyl, ethyl, propyl, isopropyl, butyl, tertiary butyl and a branched secondary alkyl group such as 2,4-dimethyl-3-pentyl. Preferably, when each R²² is the same, R²² is an isopropyl, branched secondary alkyl group or a tertiary alkyl group, in particular, tertiary butyl. Suitable examples include for the sake of example, tetra n-butyl titanate, tetra t-butyl titanate, tetra t-butoxy titanate, tetraisopropoxy titanate and diisopropoxydiethylacetoacetate titanate and/or their zirconate equivalents. Alternatively, the titanate or zirconate, typically titanate may be chelated. The chelation may be with any suitable chelating agent such as an alkyl acetylacetonate such as methyl or ethylacctylacetonate. Alternatively, the titanate may be monoalkoxy titanates bearing three chelating agents such as for example 2-propanolato, tris isooctadecanoato titanate. The molar ratio of M-OR functions to the hydroxyl groups is from 0.01:1 and 0.6:1, where M is titanium or zirconium. Alternatively, and the molar ratio of M-OR functions to the hydroxyl groups is from 0.01:1 and 0.5:1, where M is titanium or zirconium.

The silicone-based material as hereinbefore described is typically made from the condensation curable composition which is stored in a two-part manner. The two-part compositions may be mixed using any appropriate standard two-part mixing equipment with a dynamic or static mixer and is optionally dispensed therefrom for use in the application for which it is intended. In one embodiment the condensation curable composition is stored in two parts having polymer (i) and cross-linker (ii) in one part (often referred to as part A) and polymer (i) and catalyst (iii) in the other part (often referred to as part B). In an alternative embodiment the condensation curable composition is stored in two parts having cross-linker (ii) in one part and polymer (i) and catalyst (iii) in the other part. In a still further embodiment, the condensation curable composition is stored in two parts having a polymer (i) and optionally cross-linker (ii) in one part (part A) and a cross-linker (ii) and catalyst (iii) in the other part (part B).

### Additives

### Fillers

Preferably the condensation curable composition used does not contain a filler of any sort. In particular the composition preferably does not contain fillers that brings a significant amount of moisture in the composition. Suitable anhydrous filler may be utilised if required.

### Siloxane Resins

Siloxane resins comprising R²₃SiO_{1/2} units and SiO₄ units, where R² is a hydroxyl or a substituted or unsubstituted monovalent hydrocarbon radical bound directly or via an oxygen atom to the silicon atom. The monovalent hydrocarbon radical typically contains up to 20 carbon atoms R₃SiO_{1/2} typically from 1 to 10 carbon atoms. Examples of suitable hydrocarbon radicals for R² include alkyl radicals such as methyl, ethyl, propyl, pentyl, octyl, undecyl and octadecyl radicals; alkenyl radicals such as vinyl, allyl, and 5-hexenyl; cycloaliphatic radicals such as cyclohexyl and cyclohexenylethyl and aryl radicals such as phenyl, tolyl, xylyl, benzyl and 2-phenylethyl. Typically, at least one third, alternatively at least two thirds of the R² radicals are methyl radicals. Examples of R²₃SiO_{1/2} units include but are not limited to Me₃SiO_{1/2}, PhMe₂SiO_{1/2} and Me₂ViSiO_{1/2} where Me, Ph and Vi denote methyl, phenyl and vinyl respectively. The siloxane resin may contain two or more of these groups. The molar ratio of the R²₃SiO_{1/2} units and SiO_{4/2} units in the siloxane resin is typically from 0.5:1 to 1.5:1. These ratios may be measured using Si²⁹nmr spectroscopy. The siloxane resins may alternatively be reactive siloxane resins of the type defined as ingredient A of WO2014/124389, incorporated herein by reference.

### Adhesion Promoter

Suitable adhesion promoters may comprise alkoxysilanes of the formula R¹⁴_{q}Si(OR¹⁵)_{(4-q)}, where subscript q is 1, 2, or 3, alternatively q is 3. Each R¹⁴ is independently a monovalent organofunctional group. R¹⁴ can be an epoxy functional group such as glycidoxypropyl or (epoxycyclohexyl)ethyl, an amino functional group such as aminoethylaminopropyl or aminopropyl, a methacryloxypropyl, a mercapto functional group such as mercaptopropyl or an unsaturated organic group. Each R¹⁵ is independently an unsubstituted, saturated hydrocarbon group of at least 1 carbon atom. R¹⁵ may have 1 to 4 carbon atoms, alternatively 1 to 2 carbon atoms. R¹⁵ is exemplified by methyl, ethyl, n-propyl, and iso-propyl.

Examples of suitable adhesion promoters include glycidoxypropyltrimethoxysilane and a combination of glycidoxypropyltrimethoxysilane with an aluminium chelate or zirconium chelate. The curable composition may comprise 0.01% to 1% of adhesion promoter based on the weight of the composition. Preferably, the speed of hydrolysis of the adhesion promoter should be lower than the speed of hydrolysis of the cross-linker in order to favour diffusion of the molecule towards the substrate rather than its incorporation in the product network.

Suitable surfactants include silicone polyethers, ethylene oxide polymers, propylene oxide polymers, copolymers of ethylene oxide and propylene oxide, other non-ionic surfactants, and combinations thereof. The composition may comprise up to 0.05% of the surfactant based on the weight of the composition. Providing the ratios described above are met the part A and part B compositions can be mixed together in any suitable weight:weight ratio, for example from 5:1 to 1:5, alternatively from 3:1 to 1:3.

Commercial examples of the above include DOWSIL™ 9955 Encapsulation & Lamination Silicone sold commercially by Dow Silicones Corporation of Midland Michigan, USA.

In step (iii) of the method a pre-cured strip of a transparent silicone weather seal material as described above having a circular cross-section with a diameter of from 110% to 150% of the nominal joint size between the planar surface of said first building element which is transparent and the planar surface of the adjacent second building element which is optionally at least partially transparent. The diameter may alternatively 115% to 140% of the nominal joint size between the planar surface of said first building element which is transparent and the planar surface of the adjacent second building element which is optionally at least partially transparent, alternatively 115 to 135%, alternatively 115% to 130% of the nominal joint size between the planar surface of said first building element which is transparent and the planar surface of the adjacent second building element which is optionally at least partially transparent. In one embodiment the diameter of the pre-cured strip of a transparent silicone weather seal material having a circular cross-section which is greater than the nominal joint size+the maximum construction tolerance (as hereinbefore defined). For example, nominal joint size (cavity width) might be for the sake of example 12 mm, with for example the maximum construction tolerance being up to from 2 to 3 mm and the minimum construction tolerance being up to from 2 to 3 mm for which the building plans allow a total cavity width (construction tolerance) of up to from 4 to 6 mm on site. Hence, in the case of a 2 mm maximum construction tolerance and a 2 mm minimum construction tolerance allows for the cavity width to vary between 10 mm to 14 mm and the pre-cured strip of transparent silicone weather seal material during use needs the ability to accommodate such variation when inserted into the cavity. After the completion of steps (i) and (ii) said pre-cured strip of a transparent silicone weather seal material is compressed manually and/or using e.g., a suitable tool and is guided into the cavity and then released to enable the pre-cured weather seal to expand and so far as possible return to its original shape, but in doing so expanding to fill the cavity width between the two adjacent planar surfaces, ensuring good contact/wetting with the one component, translucent silicone sealant composition applied in step i) and ii) and seal the width of the cavity irrespective of the nominal joint size and is able to accommodate said predetermined expansion tolerance and predetermined contraction tolerance. The pre-cured strip of a transparent silicone weather seal material is preferably inserted deep enough in the cavity, so that it does not project beyond the glass lines (upper planes) of the adjacent first and second building elements. Once the positioning of said pre-cured strip of a transparent silicone weather seal material is satisfactory step (iv) may be undertaken and any excess one component, translucent silicone sealant applied in step (i) or step (ii) or caused by the insertion of the pre-cured strip of transparent silicone weather seal material during step (iii) is removed. Subsequently, in step (v) the remaining one component, translucent silicone sealant is left to cure. If/when masking tape is applied to the surrounding area during the method, the masking tape may be removed upon completion of step (iv) or during or after step (v).

If the length of the cavity between the first and second building elements, is longer than a single pre-cured strip of transparent silicone weather seal material, i.e., if the first and second building elements are longer than a single pre-cured strip of a transparent silicone weather seal material, two pre-cured strips of a transparent silicone weather seal material be adhered together and then any excess of the combined pre-cured transparent weather seals can be removed upon completion of step (iii) of the method. If two (or more) pre-cured strips of a transparent silicone weather seal material are to be adhered together (at the ends to make one preferably extended pre-cured strip of transparent silicone weather seal material of extended length) this can be easily achieved by applying a coating of the one component, translucent silicone sealant used in steps (i) and (ii) onto one or both ends of pre-cured strip of a transparent silicone weather seal material then putting them in contact and allowing the one component, translucent silicone sealant to cure. This provides a near seamless but strong bond allowing multiple pre-cured strips of transparent silicone weather seal material to be adhered together if required depending on the dimensions of cavity.

It is essential that a weather seal does not discolour with age. An advantage provided by the present disclosure is that transparency is retained with aging and no discolouration was identified during testing by being exposed outdoors for one year. The urban environment in which it was confidentially tested involved periods with high dust, high temperature i.e., up to and even greater than 35° C., e.g., 35° C. to 40° C. and humidity as well as periodic heavy rains and in the absence of rain periodic applications of water and it was found that none of these were observed to negatively affect the crystal-clear appearance of the pre-cured strip of transparent silicone weather seal material. No yellowing was observed. Two small test samples of the circular or oval shaped preformed weather seal were tested using a standard test in the façade industry equivalent to a typical lifetime exposure (ASTM C1087). No discolouration (yellowing) was observed after being exposed under UV in in an oven (340 lamps) for 5000 hours.

It was found that the pre-cured strips of transparent silicone weather seal material herein provided good movement capability for the weather seals resulting from the method herein in accordance with ISO 11600. No cohesive failure and/or adhesion failure and no specimen damage was found. The proposed configuration of applying a thin bead of translucent sealant to adhere the pre-cured strips of transparent silicone weather seal material in the cavity formed between the adjacent first and second building elements which need to be sealed is a new innovative way for weather sealing applications. The building elements may include but are not restricted to silicone structural glazing units (SSG), insulating glazing units (IGUs), monolithic transparent panels, laminated transparent units and they may be utilised in either exterior and interior building applications such as, for the sake of example, curtain wall facades, transparent walls, e.g., glass walls, at least partially transparent cable net facades, cable net walls, transparent shop fronts, transparent skylights, and transparent conservatories and the like.

This method will reduce sealant waste on site when compared to traditional method of using typical caulking sealant. Finally, this method can be used in the preparation of weather seals between building elements for a wide variety of applications such as in either exterior and interior building applications such as, for the sake of example, curtain wall facades, corners, tapered façades, faceted facades, curved façades, hot bent glass façades/units, glass walls, cable net walls, shop fronts, skylights, conservatories and the like.

### FIGURES

FIGS. 1a and 1b depict a weather seal having been formed in a cavity between a planar surface of a first building element and a facing planar surface of an adjacent second building element as hereinbefore described with the building elements in the same plane and the planar surfaces are parallel to each other.

FIG. 1c depicts a weather seal having been formed in a cavity between a planar surface of a first building element and a planar surface of an adjacent second building element as hereinbefore described but where the building elements are out of planar alignment.

FIG. 1d depicts a weather seal having been formed in a cavity between a planar surface of a first building element and a planar surface of an adjacent second building element as hereinbefore described but where the facing planar surfaces are not parallel.

FIG. 2 depicts a weather seal having been formed in a cavity between a planar surface of a first building element and a planar surface of an adjacent second building element as hereinbefore described but where the facing planar surfaces form an approximately 90° corner.

FIGS. 3a and 3b are depictions of an embodiment of FIG. 1a where the first and second building elements are both insulated glass units.

FIGS. 4a and 4b are depictions of an embodiment of FIG. 1a where the first building element is an insulated glass unit and the second building element is a laminated glass unit.

The Figures herein are provided to depict a variety of possible alternative embodiments of the invention in which the method of making the weather seal can be utilised. In each embodiment shown it is assumed that the method described herein has been utilised to form the weather seal between the two building elements.

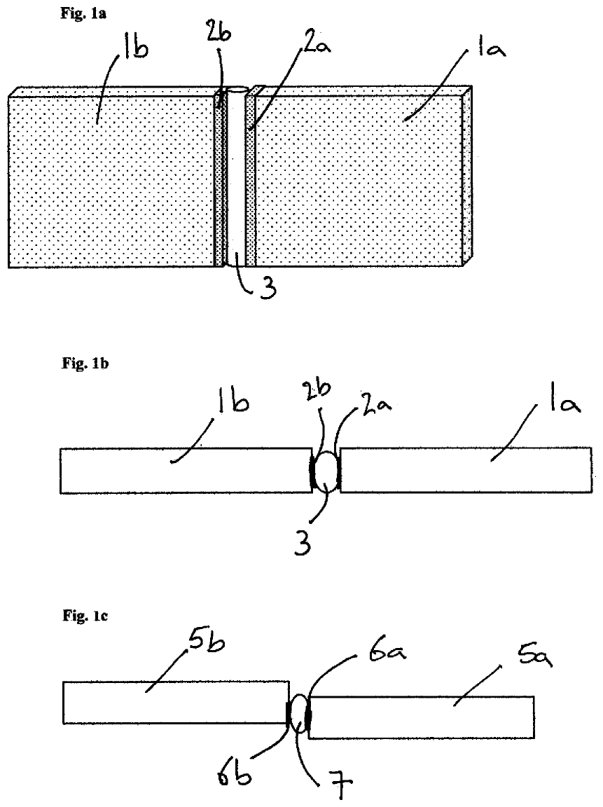

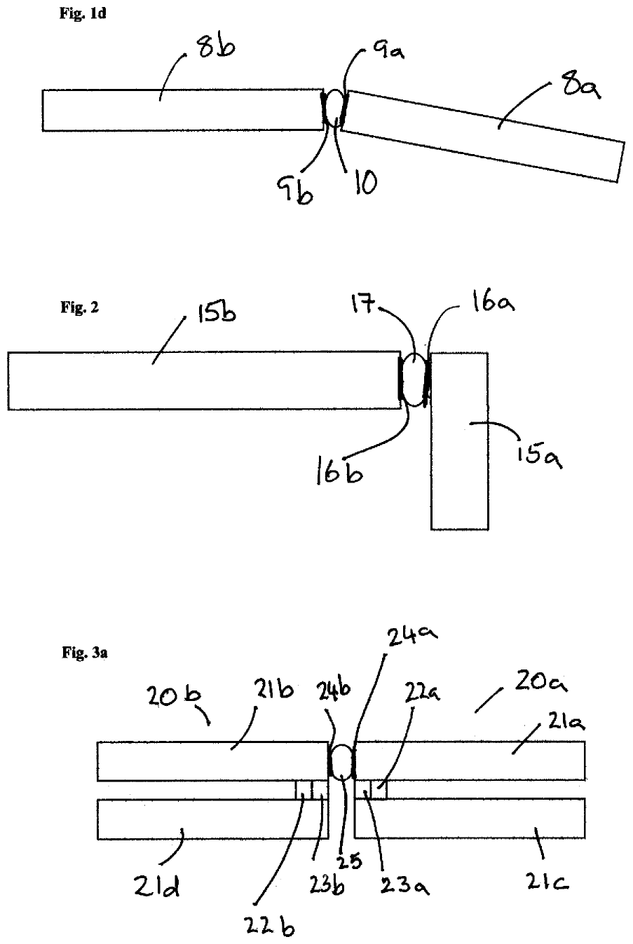

Referring to FIGS. 1a and 1b, there is provided an embodiment of the weather seal prepared by the method herein, in which building elements 1a and 1b are in the same plane and have adjacent facing planar surfaces between which is a cavity which has been weather sealed using the method as described herein. The weather seal comprises a cured layer of one component, translucent silicone sealant composition 2a, 2b on each facing planar surface of respective building elements 1a and 1b and before curing said layers a pre-cured strip of a transparent silicone weather seal material 3 having a circular or oval cross-section with a diameter of from 110% to 150% is inserted therebetween. A weather seal is achieved when the layers of one component, translucent silicone sealant composition 2a, 2b have been allowed/enabled to cure sealing said cavity.

In FIG. 1c there is provided an embodiment of the weather seal provided by the method herein building elements 5a and 5b are not in planar alignment but a cavity is provided between the facing planar surfaces where they do align and a weather seal is provided therebetween comprising layers of one component, translucent silicone sealant composition 6a and 6b on the facing planar surfaces of building elements 5a and 5b respectively with a pre-cured strip of a transparent silicone weather seal material 7 having been inserted therebetween in accordance with the method described herein.

In FIG. 1d there is provided a further embodiment of a weather seal obtained by following the method described herein where the facing walls of building components 8a and 8b have been treated respectively with a layer of one component, translucent silicone sealant composition 9a and 9b and a pre-cured strip of a transparent silicone weather seal material 10 as defined herein forms a weather seal in the cavity between said facing planar surfaces once the layer of one component, translucent silicone sealant composition have been allowed/enabled to cure. In this instance the facing planar surfaces are not parallel to each other and as such the weather seal is sealing a joint on a curve or the like.

In FIG. 2 herein there is provided a further embodiment of the weather seal formed by the method in accordance with the method described herein wherein the weather seal provided in accordance with the method herein is formed between two planar surfaces of building elements 15a and 15b which are perpendicular to each other and as such the weather seal produced forms a joint at the corner therebetween with the pre-cured strip of a transparent silicone weather seal material 17 inserted in the cavity formed between the two facing planar surfaces subsequent to the application of layers of one component, translucent silicone sealant composition 16a and 16b had been applied onto the facing planar surfaces.

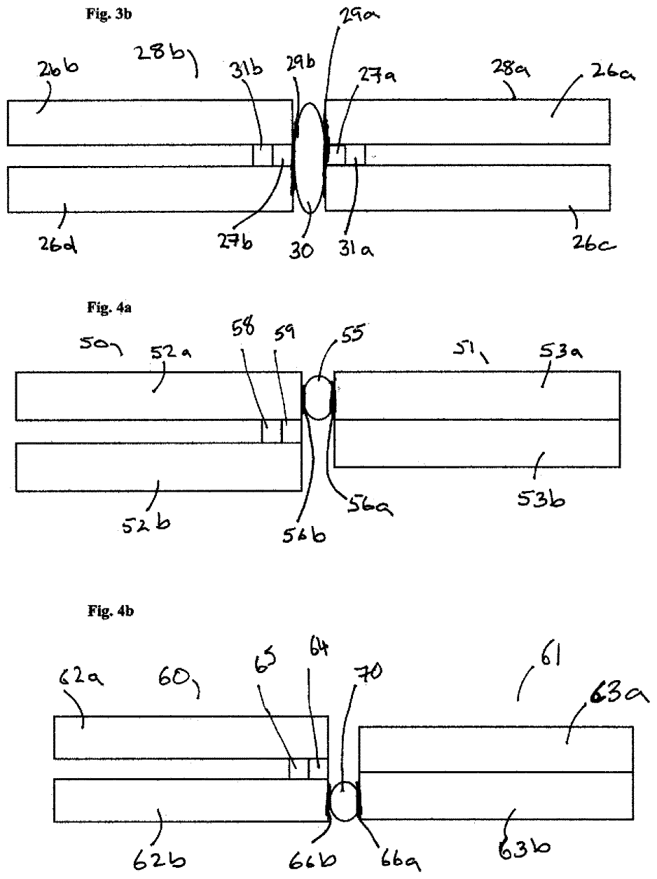

In FIG. 3a there is provided a further embodiment where the building elements 20a and 20b are both insulated glass units (IGUs). In IGU 20a (partially shown) there is a first pane of glass 21a and a second pane of glass 21c, separated using a spacer 22a and a secondary silicone sealant 23a. Similarly, In IGU 20b (partially shown) there is a first pane of glass 21b and a second pane of glass 21d, separated using a spacer 22b and a secondary silicone sealant 23b. In this embodiment, a weather seal has been prepared following the method as described herein with the seal being solely between the outer most panes of glass 21a and 21b. A layer of one component, translucent silicone sealant composition 24a and 24b had been applied to the facing planar surfaces of glass panes 21a and 21b respectively and a pre-cured strip of a transparent silicone weather seal material 25 has been inserted therebetween. Alternatively, if desired. a layer of one component, translucent silicone sealant composition equivalent to 24a and 24b may additionally be applied to the facing planar surfaces of glass panes 21c and 21d respectively and a pre-cured strip of a transparent silicone weather seal material equivalent to weather seal material 25 may be inserted therebetween such that there are two pre-cured strips of a transparent silicone weather seal material in the cavity between IGUs 20a and 20b. Similarly, of course, should the IGU comprise three or more glass panes further pre-cured strip of transparent silicone weather seal material equivalent to weather seal material 25 can be introduced in a similar fashion between each pair of panes.

In FIG. 3b there is provided a still further embodiment where the building elements 28a and 28b are both insulated glass units (IGUs). In IGU 28a (partially shown) there is a first pane of glass 26a and a second pane of glass 26c, separated using a spacer 31a and a secondary silicone sealant 27a. Similarly, In IGU 28b (partially shown) a there is a first pane of glass 26b and a second pane of glass 26d, separated using a spacer 31b and a secondary silicone sealant 27b. In this embodiment, a much deeper/larger weather seal has been prepared following the method as described herein with the seal being prepared across the whole planar surfaces of the IGUs facing each other, i.e. the weather seal encompasses a joint formed by a layer of one component, translucent silicone sealant composition 29a and 29b applied to the facing planar surfaces of IGUs 28a and 28b respectively which encompasses all four panes of glass e.g., 26a and 26c in respect of IGU 28a and 26b and 26d in respect of IGU 28b and a larger pre-cured strip of a transparent silicone weather seal material 30 has been inserted therebetween to form the weather seal once the layers of one component, translucent silicone sealant composition 29a and 29b were allowed/enabled to cure.

In FIG. 4a the first building element is a laminated glass unit 51 and the second building element is an insulated glass unit 50 showing that the method described herein is suitable to form weather seals between different types of building elements. In the case of laminated glass unit 51 comprises two panes of glass 53a and 53b which have been laminated together and in insulated glass unit 50 there is a first pane of glass 52a and a second pane of glass 52b, separated using a spacer 58 and a secondary silicone sealant 59. In this instance the two building elements 51 and 50 are of different thicknesses. In FIG. 4a, uppermost panes of glass 53a and 52a are aligned to be in the same plane and the weather seal has been provided across the cavity between the upper most panes of glass 53a and 52a. A layer of one component, translucent silicone sealant composition 56a and 56b had been applied to the facing planar surfaces of glass panes 53a and 52a respectively and a pre-cured strip of a transparent silicone weather seal material 55 has been inserted therebetween.

In FIG. 4b, like FIG. 4a the first building element is again a laminated glass unit 61 and the second building element is an insulated glass unit 60 showing that another embodiment using the method described herein to form weather seals between different types of building elements. In the case of laminated glass unit 61 comprises two panes of glass 63a and 63b which have been laminated together and in insulated glass unit 60 there is a first pane of glass 62a and a second pane of glass 62b, separated using a spacer 65 and a secondary silicone sealant 64. In this instance the two building elements 61 and 60 are of different thicknesses. In FIG. 4b, lowermost panes of glass 62b and 63b are aligned to be in the same plane and the weather seal has been provided across the cavity between said lowermost panes of glass 62b and 63b. A layer of one component, translucent silicone sealant composition 66a and 66b had been applied to the facing planar surfaces of glass panes 63a and 62b respectively and a pre-cured strip of a transparent silicone weather seal material 70 has been inserted therebetween.

### Examples

Examples using a pre-cured strip of transparent silicone weather seal material having a solid square cross-section, as used as a weather seal for spacing e.g., a glass pane from a frame and/or two adjacent glass panes from each other in an insulating glazing unit using an analogous method as used in WO/2018/160325. Each pre-cured strip of transparent silicone weather seal material was prepared using DOWSIL™ 9955 Encapsulation & Lamination Silicone which is commercially available from Dow Silicones Corporation of Midland, Michigan, USA. As determined in WO/2018/160325 each substrate surface was treated with a suitable primer to first form an intermediate layer” or “reactive interlayer”. For this example, a commercial primer DOWSIL™ 1200 OS Primer from Dow Silicones Corporation of Midland, Michigan, USA was applied in accordance with step (i) and step (ii) as described above. To obtain adhesion, primer 1200 OS needs to be applied on the substrate onto which the pre-cured strip of transparent silicone weather seal material has to develop adhesion and not on to the pre-cured strip of transparent silicone weather seal material itself. A certain open time needs to be respected before putting the weather seal in contact. The pre-cured strip of a transparent silicone weather seal material needs to be pushed in place while ensuring good wetting with the first and second planar surfaces of the adjacent at building elements. It was found that the primer quantity needed to be well dosed to avoid white streaks and lower adhesion performance. It was also found that access to the edge of the first and second planar surfaces of the adjacent building elements (e.g., glass) was not easy on a construction site situation and it was found that insertion of the pre-cured strip of transparent silicone weather seal material having a square cross-section proved to be making the method of applying the intermediate layer” or “reactive interlayer” followed by the insertion of the pre-cured strip of a transparent silicone weather seal material was both difficult and time consuming. The cavity nominal joint size used for this example was an average of 12 mm and a pre-cured strip of a transparent silicone weather seal material having a square cross-section was inserted into the cavity in the equivalent of step (iii) herein. It was found that once positioned in the cavity realignment was, at best, exceptionally difficult but usually not possible without damaging the pre-cured strip of a transparent silicone weather seal material.

The resulting sample was tested for suitable movement properties in respect to ISO11600. As previously discussed, building elements as hereinbefore described undergo movement due to thermal expansion and contraction of the building materials including the building elements between which the cavity is generated which is weather sealed in accordance with the method herein, wind load and/or other dynamic deformation especially when used on high rise buildings. In accordance with ISO11600 no air or water infiltration can occur during movement i.e., water tightness is required under dynamic movement and the resulting weather sealed sample was found not to provide sufficient adhesion under movement cycling test.

Given it was decided that the above weather sealing method was unsatisfactory, an alternative (comparative) method was assessed. In the alternative method the commercial primer was replaced with part B composition of used to make the spacer in WO/2018/160325 comprising silicone polymer and cure catalyst in this example the part B composition DOWSIL™ 9955 Encapsulation & Lamination Silicone which is commercially available from Dow Silicones Corporation of Midland, Michigan, USA was utilised. In this instance it was found that it was unnecessary to apply the part B composition on the first and second planar surfaces of the adjacent building elements (e.g., glass) as it was also possible to apply one or more thin beads of the part B composition on the pre-cured strip of a transparent silicone weather seal material of the part B composition along the length of the prc-cured strip of a transparent silicone weather seal material being introduced into the cavity. In this instance it was found to be easier to load the pre-cured strip of transparent silicone weather seal material having a square cross-section into the cavity as the part B composition of DOWSIL™ 9955 Encapsulation & Lamination Silicone initially functioned as a means of lubrication to assist the introduction of the pre-cured strip of transparent silicone weather seal material into the cavity.

The following method was utilised:
(a) Close the rear side of the cavity formed between the first and second planar surfaces of the building elements (e.g., glass façades) with a suitable backing/support.
(b) Apply part B of DOWSIL™ 9955 Encapsulation & Lamination Silicone directly on the edges of the pre-cured strip of transparent silicone weather seal material or on the glass edge, whichever easier instead of the glass, saving time and facilitating access using any suitable application means e.g., with a brush and/or dipping,
(c) Insert the pre-cured strip of a transparent silicone weather seal material partially coated with part B of DOWSIL™ 9955 Encapsulation & Lamination Silicone in accordance with step
(b) into the cavity typically with a gentle hand push, (given the lubrication affect created by the part B composition;
(d) Apply a thin layer of part B on the exposed face of the pre-cured strip of a transparent silicone weather seal material,
(e) While part B is developing the adhesion and curing, the pre-cured strip of a transparent silicone weather seal material was protected from dirt or water for a pre-determined period of time in the case of this example for about two days.

It was determined that the weather seals made via this method did not have a strong enough tensile strength and consequently not good enough movement capacity.

Consequently, from a third series of experiments it was unexpectedly determined that the best means of adhering said pre-cured strip of a transparent silicone weather seal materials to the adjacent planar surfaces of the first and second building elements was by means of a layer of a one component, translucent silicone sealant composition coated onto the planar surfaces of the first and second building elements before insertion of the pre-cured strip of a transparent silicone weather seal material. The use of such a standard translucent sealant as the “intermediate layer” or “reactive interlayer” between the pre-cured strip of a transparent silicone weather seal material and each of the adjacent first and second building elements, improves the tensile strength and therefore movement capacity of the weather seal between the adjacent planar surfaces of the first and second building elements and the pre-cured strip of transparent silicone weather seal material after its insertion. The applications of thin layers of said sealants onto the first and second building elements was unexpectedly found not to have a negative effect on transparency. Furthermore, it was found that using part B of the DOWSIL™ 9955 Encapsulation & Lamination Silicone resulted in a weather seal having less movement than weather seals prepared utilising DOWSIL™ 791T Silicone Weatherproofing Sealant and as a consequence it was found the “part B” method did not pass ISO 11600 at 12.5%, whilst the weather seal utilising DOWSIL™ 791T Silicone Weatherproofing Sealant was strong enough to pass ISO11600 providing a suitable pre-cured strip of transparent silicone weather seal material with an acceptable cross-section could be identified.

Furthermore, the weather seal utilising DOWSIL™ 791T Silicone Weatherproofing Sealant was strong enough to pass ISO11600 providing a suitable pre-cured strip of transparent silicone weather seal material with an acceptable cross-section could be identified.

The layer of one component, translucent silicone sealant, DOWSIL™ 791T Silicone Weather sealing Sealant, can be applied in any suitable manner on the planar surfaces of the adjacent first and second building elements prior to insertion of the pre-cured strip of transparent silicone weather seal material. In one embodiment it may be applied as a thin beading around the edges of each of the sides of the first and second building elements to be adhered to the pre-cured strip of transparent silicone weather seal material, in order to maintain the transparent appearance of the weather seal arrangement resulting from the method herein via steps (i), (ii) and (iii) of the method described herein. It was also found that whilst the one component, translucent silicone sealant used here functioned initially as a lubricant, with respect to the insertion of the pre-cured strip of a transparent silicone weather seal material, a rear support was unnecessary unlike when the DOWSIL™ 9955 Encapsulation & Lamination Silicone part B composition was being used.

A further issue had become apparent during the preparation of the above examples. It was realised that a pre-cured strip of a transparent silicone weather seal material with a square cross-section having, approximately, the same width as the nominal joint size, only functions well in an ideal situation, i.e., where there is no deviation in accordance with the predetermined construction tolerance with respect to the in the nominal joint size. However, it was determined that this was rarely the case along the whole length of the cavity between said adjacent building elements, even if the nominal joint size was suitable for the pre-cured strip of a transparent silicone weather seal material with a square cross-section. In reality, due to construction tolerances of e.g., glass panes in the adjacent first and second building elements, the cavity width can vary in accordance with the predefined construction tolerances in which case a satisfactory weather seal may not be achieved.

It was determined that whilst pre-cured spacers having a square or rectangular cross-section were preferred when used as spacers, the same was not the case for this application. Whilst pre-cured strips of transparent silicone weather seal material having a square cross section were able to accommodate a slightly smaller cavity nominal joint size as it was found to have limited compressibility, it was not able to expand to seal a cavity having a larger cavity width or a partially wider cavity width and furthermore because they were difficult to compress the pre-cured strip of a transparent silicone weather seal material s having a square or rectangular cross-section tended to be damaged during installation in the cavity.

As such a series of pre-cured strips of a transparent silicone weather seal material s having various cross-sectional shapes were made using DOWSIL™ 9955 Encapsulation & Lamination Silicone and these were assessed for ease of use and ability to form a weather seal in a cavity between the adjacent planar surfaces of said first and second building elements for use in cavities as described herein having a nominal joint size of 12 mm, and the need to accommodate an construction tolerance of ±2 mm such that installation needed to accommodate a possible variation in cavity width of from 10 mm to 14 mm.

Each pre-cured strip of a transparent silicone weather seal material assessed had a different cross-sectional shape and were designed to be cross-sectionally wider in some way than the nominal joint size of the cavity into which they are to be placed or were at least cross-sectionally of a different shape so that they had to be compressed when being inserted and allowed to expand after having been introduced into the cavity. The different cross-section shapes assessed are shown in Table 1a below.

TABLE 1a
Cross-section shapes assessed to identify the circular
cross-section as being required as described herein

| Terminology used | Shape |
|---|---|
| Solid square | [symbol] |
| Hollow square | [symbol] |
| Solid circular | [symbol] |
| Hollow circular | [symbol] |
| Half-moon | [symbol] |

For the tests undertaken the first and adjacent second building elements used were both samples of laminated glass units in which two panes of glass, each of 10 mm thickness laminated together. For the test purposes they were position so as to form a cavity therebetween having a nominal joint size of 12 mm and allowing for a ±2 mm construction tolerance. Furthermore, the depth of the cavity was approximately 20 mm and the length of each cavity was approximately 30 cm.

As discussed in more detail below, the different pre-formed weather seal cross-sections prepared were designed to be 15 mm wide at the widest, i.e., 25% greater than the nominal joint size and greater at their widest point than the nominal joint size+the maximum increase permitted by the construction tolerance. The increased cross-sectional size in the different pre-cured strips of transparent silicone weather seal material tested was to ensure they had to be compressed when being introduced into said cavity and consequently expanded to engage both respective adjacent planar sides of the first and second building elements.

### Solid Square Cross-Section

A square cross section of 15 mm by 15 mm was used to seal a cavity of the dimensions described above. A square cross section of 15 mm by 15 mm was used to seal a cavity having a nominal joint size of 12 mm and 20 mm depth. This shape is able to accommodate movements of the nominal joint size of 12 mm with a construction tolerance of ±2 mm, i.e., it was considered that a pre-cured strip of a transparent silicone weather seal material of this cross-sectional shape could accommodate a construction tolerance of 16.7% relative to the nominal joint size. The solid square cross-sectioned pre-cured strip of a transparent silicone weather seal material was found to be difficult to compress during installation (step (iii) which at times resulted in damage to pre-cured strip of transparent silicone weather seal material during installation, especially if attempts were made to compress the strip to less than 10 mm width during insertion.

Once, installed providing the pre-cured strip of transparent silicone weather seal material was undamaged the weather seal had an excellent degree of transparency (based on human observation). In conclusion it was considered to be too difficult to compress the pre-cured strip of a transparent silicone weather seal material having a solid square cross-section which at times lead to the weather seal being damaged or sometimes it was found to flip/twist and bounce thereby effectively resisting insertion.

### Hollow Square Cross-Section

A hollow square shape of 15 mm external edge and with a surface thickness of 3 mm was prepared. This shape can be used to seal cavities having a nominal joint size of 12 mm which can vary between a maximum compression of 5 mm and a maximum expansion of 13 mm, i.e., it was considered that a pre-cured strip of a transparent silicone weather seal material of this cross-sectional shape could accommodate a construction tolerance of approximately 44.4% relative to the nominal joint size. The insertion of the hollow square shape into the cavity proved to be difficult and it was found that the shape and especially of the interior cavity of the hollow square cross-section could be damaged during compression and insertion of this pre-cured strip of a transparent silicone weather seal material into the cavity. Similar to the half-moon shape (see below), it was found that this pre-cured strip of transparent silicone weather seal material surfaces did not fully contact the glass. Furthermore, the aesthetic appearance of such a weather seal was poor because having a non-solid/continuous cross-section of the transparent silicone negatively affected transparency.

### Solid Circular Cross Section

Analogous tests were undertaken using pre-cured strip of a transparent silicone weather seal material having a solid circular cross-section of 15 mm diameter can be used for a nominal joint size of 12 mm and a depth of 20 mm. It allowed for a construction tolerance of ±2 mm and therefore, like the solid square cross-sectional shape, it was considered that a pre-cured strip of a transparent silicone weather seal material of this cross-sectional shape could accommodate a construction tolerance of 16.7% relative to the nominal joint size. It was found that a pre-cured strip of a transparent silicone weather seal material having a solid circular cross-section did not require a backer rod support which was a surprising added bonus support in place, gave good engagement and was able to be compressed easily and expanded to completely fill the cavity thereby providing an excellent weather seal. It was found however that in one embodiment herein in step (iii), in the case where the cavity to be sealed weather sealed is of a depth greater than twice the depth of the pre-cured strip of a transparent silicone weather seal material, a second pre-cured strip of a transparent silicone weather seal material can be inserted on top of the first pre-cured strip of a transparent silicone weather seal material, after a layer of the one component, translucent silicone sealant composition has been applied on said first pre-cured strip of a transparent silicone weather seal material once it has been secured in place.

The pre-cured strip of a transparent silicone weather seal material having a solid circular cross section was far easier to insert into the cavity than the solid square cross-section pre-cured strip of a transparent silicone weather seal material. Furthermore, its aesthetic appearance of such a weather seal was excellent. A pre-cured strip of a transparent silicone weather seal material having oval cross-section with a similar diameter, i.e., diameter along the semi-major axis would work equally well for the same reasons as the solid circle, for example a pre-cured strip of a transparent silicone weather seal material having an elliptical cross-section.

### Hollow Circular Cross Sections

The pre-cured strip of a transparent silicone weather seal material having a hollow circular cross section had the same maximum expansion and compression values as the hollow square cross-section and thus it was considered that a pre-cured strip of a transparent silicone weather seal material of this cross-sectional shape could accommodate a construction tolerance of 44.4% relative to the nominal joint size with additional benefit of easy installation thanks to the circular cross-section. The manufacturing of this hollow shape was however found difficult and was not considered suitable for the method described herein, especially as the transparency of a strip of this cross-section was also poor.

### Half-Moon Cross-Section

It was found that a pre-cured strip of a transparent silicone weather seal material having a half-moon cross-section having a widest point of 17 mm and as a smallest curvature of 15 mm and was suitable to seal a cavity having a nominal joint size 12 mm. It was considered that a pre-cured strip of a transparent silicone weather seal material of this cross-sectional shape could accommodate a construction tolerance of 44.4% relative to the nominal joint size The convex side of the pre-cured strip of a transparent silicone weather seal material having a half-moon cross-section was found to be easily inserted into the cavity as might be expected but it was found when released to expand once inserted in the cavity a weather seal of this cross-sectional shape tended to buckle, bend back, twist and flip at its edges/wings due to its high flexibility. As a result, such a pre-cured strip of a transparent silicone weather seal material proved unsuitable for use in the weather seal prepared in accordance with the method described herein because good contact with each adjacent planar surface was very difficult to achieve and as such adhesion of the weather seal in the cavity was poor which was considered a fatal flaw unless the wings could have been strengthened in some way. However, no further effort was undertaken using such a shape as the aesthetic appearance of such a joint was also poor due to the concave shape.

The above results are summarized in Table 1b below with the values for construction tolerance shape can accommodate (%) being relative to the nominal joint size.

TABLE 1b
Assessment of Suitability of cross-sectional shape for pre-cured
strip of a transparent silicone weather seal material

| Cross-sectional | Construction | | | | |
|---|---|---|---|---|---|
| shape of pre- | Tolerance shape can | | | | |
| cured strip | accommodate (%) | | Installation | Aesthetics | Remark |
| Solid square | 16.7% | (medium) | Difficult | Good | |
| Hollow square | 44.4% | (high) | Difficult | Bad | Adhesion of |
| | | | | | edges, inner core |
| Solid circular | 16.7% | (medium) | Easy | Good | No need for |
| | | | | | backing support |
| Hollow circular | 44.4% | (high) | Easy | Bad | Inner core |
| Half-moon | 44% | (good) | Acceptable | Acceptable | Concave |

appearance

Based on the above comparison, going forward the solid circular cross-section was used and such weather seals having solid circular cross sections were subsequently further evaluated.

### Connection of Weather Seals

It was determined experimentally that the ends of two lengths of solid circular cross-sectional weather seals as described herein can be adhered together, almost seamlessly, using a thin layer of DOWSIL™ 791T Silicone Weatherproofing Sealant (which is translucent when used in thick layers e.g., less than or equal to 5 mm thick layers). Hence if the cavity channel is longer than a single length of pre-cured strip of transparent silicone weather seal material, bonding two together is a feasible option. Such bonding can be designed to be undertaken in the lower or upper part of a façade, i.e., not at direct sightline. Likewise for deep cavities it is possible to bond two pre-cured strips of transparent silicone weather seal material one on top of another with a thin layer of DOWSIL™ 791T Silicone Weatherproofing Sealant used as adhesive to adhere them together.

Discolouration with Aging & Dirt Pick-Up

Samples of the transparent pre-cured strips of transparent silicone weather seal material having a solid circular cross-section were left out in the environment exposed for one year. The environment in which the samples were confidentially tested was urban with high dust, high temperature variations, UV and humidity, combined with periodic heavy rains and daily watering plant from tap water. This weathering which it is believed included exposure to acid rain did not visibly affect the crystal-clear appearance of the weather seal. No yellowing was observed. Furthermore, it was found that any dirt pick noticed could be easily removed through water cleaning using normal water hose and if necessary, wiping or the like.

To assess the effect of UV exposure, a pre-cured strip of a transparent silicone weather seal material having a solid circular cross-section was prepared from DOWSIL™ 9955 Encapsulation & Lamination Silicone. Two small test samples of the solid circular cross-sectioned pre-cured strip of a transparent silicone weather seal material were prepared and assessed for UV resistance in accordance with ASTM C1087-16. Samples were placed in an oven (340 lamps) for 5000 hours which is a standard test in the façade industry equivalent to a typical lifetime of UV exposure. No yellowing was observed.

### Water Penetration Testing

Samples of the solid circular transparent pre-cured strip of a transparent silicone weather seal material inserted into a cavity between two adjacent planar surfaces of said first and second building elements were abrasion tested in accordance with the American Architectural Manufacturers Association (AAMA) standard AAMA 501.1 water field test on site by using a water jet at 140 bar (14 MPa) with 30 cm distance from glass surface for a period of five minutes during 5-minute. It was found that no damage to the weather seal comprising the pre-cured strip of a transparent silicone weather seal material having a solid circular cross-section was observed which therefore confirms good resistance to water penetration and as such this would also resist the impact for window cleaning.

Furthermore, the above water pressure “cleaned” sample was evaluated for watertightness under movement. A pre-cured strip of a transparent silicone weather seal material having a solid circular cross-section was inserted into a cavity between two adjacent planar surfaces of first and second building elements (glass panes). The weather seal between the glass panes was deformed by fixing one of the panes of glass in an unmoving position and moving the second glass pane. During deformation a rubber band is used to provide a water reservoir above the weather seal to identify leakage through the seal. The moveable glass pane was moved for ten cycles and no water leakage was observed indicating that the weather seal remained sound.

1. A method of weather sealing a cavity having a pre-defined nominal joint size, formed between a planar surface of a first building element which is transparent and a planar surface of an adjacent second building element which is facing the planar surface of the first building element and which is optionally at least partially transparent, the method comprising the steps of:
(i) applying a coating of a one component, translucent silicone sealant composition on the planar surface of either the first or second building element;
(ii) applying a coating of a one component, translucent silicone sealant composition on the planar surface of the other of the first or second building element;
(iii) inserting a pre-cured strip of a transparent silicone weather seal material having a circular or oval cross-section with a diameter of from 110% to 150% of the pre-defined nominal joint size between the planar surface of the first building element which is transparent and the planar surface of the adjacent second building element which is optionally at least partially transparent facing each other;
(iv) removing any excess one component, translucent silicone sealant composition applied in step (i) or step (ii) subsequent to step (iii); and
(v) allowing or enabling the remaining one component, translucent silicone sealant composition to cure and form a weather seal by adhering the pre-cured strip of a transparent silicone weather seal material inserted in step (iii) to both the first and second building elements.

2. The method of weather sealing a cavity in accordance with claim 1, wherein the circular or oval cross-section of the pre-cured strip of a transparent silicone weather seal material of step (iii) has a diameter of from 115% to 130% of the nominal joint size between the planar surface of the first building element which is transparent and the planar surface of the adjacent second building element which is optionally at least partially transparent.

3. The method of weather sealing a cavity in accordance with claim 1, wherein the diameter of the pre-cured strip of a transparent silicone weather seal material having a circular or oval cross-section is greater than the sum of the nominal joint size+construction tolerance.

4. The method of weather sealing a cavity in accordance with claim 1, wherein the diameter of the pre-cured strip of a transparent silicone weather seal material when having an oval cross-section is along the semi-major axis and/or wherein the oval cross-section is an elliptical cross-section.

5. The method of weather sealing a cavity in accordance with claim 1, wherein the first building element is selected from insulating glazing units (IGUs), a monolithic glass panel, or a laminated building element, or a polymethylmethacrylate unit.

6. The method of weather sealing a cavity in accordance with claim 5, wherein both the first and second building elements are selected from insulating glazing units (IGUs), a monolithic glass panel, or a laminated building element, or a polymethylmethacrylate unit.

7. The method of weather sealing a cavity in accordance with claim 1, wherein the pre-cured strip of a transparent silicone weather seal material is the cured product of a bulk cured room temperature condensation curable silicone composition comprising:
(i) at least one condensation curable silyl terminated polymer having an average of at least 1.5, optionally an average of at least two, hydrolysable and/or hydroxyl functional groups per molecule;
(ii) a cross-linker selected from the group of
silanes having at least two hydrolysable groups, optionally at least three hydrolysable groups, per molecule; and/or
silyl functional molecules having at least two silyl groups, each silyl group containing at least one hydrolysable group; and
(iii) a condensation catalyst selected from the group of titanates and zirconates and having M-OR functions;
wherein:
the molar ratio of hydroxyl groups to hydrolysable groups is between 0.1:1 to 4:1; and
the molar ratio of M-OR functions to the hydroxyl groups is from 0.01:1 and 0.6:1, where M is titanium or zirconium and R is an alkyl group.

8. The method of weather sealing a cavity in accordance with claim 1, wherein the nominal joint size of the cavity is in a range of 5 to 50 mm.

9. The method of weather sealing a cavity in accordance with claim 1, wherein masking tape is applied to the edge regions of each face of the first and/or second building element(s) not treated in step (i) or step (ii) in order to protect the same.

10. The method of weather sealing a cavity in accordance with claim 1, wherein no backer rods are inserted into the cavity prior to commencement of the method.

11. The method of weather sealing a cavity in accordance with claim 1, wherein in step (iii), for cavities of a depth greater than twice the depth of the pre-cured strip of a transparent silicone weather seal material, a second pre-cured strip of a transparent silicone weather seal material can be inserted on top of the first pre-cured strip of a transparent silicone weather seal material, after a layer of the one component, translucent silicone sealant composition has been applied on the first pre-cured strip of a transparent silicone weather seal material once it has been secured in place.

12. The method of weather sealing a cavity in accordance with claim 1, wherein after step (iii), a coating of the one component, translucent silicone sealant composition is applied onto the pre-cured strip of a transparent silicone weather seal material subsequent to insertion into the cavity to enhance the clarity/transparency of the strip of a transparent silicone weather seal material.

13. A weather sealed cavity having a pre-defined nominal joint size, formed between planar surfaces of a first building element which is transparent and an adjacent second building element which is optionally at least partially transparent and which is the product of the method in accordance with claim 1.

14. The weather sealed cavity in accordance with claim 13, which forms part of an exterior and interior building application.

15. The weather sealed cavity in accordance with claim 13, in a curtain wall facade, glass wall, cable net façades, shop front, skylight, or conservatory.

16. (canceled)
